(19) United States
(12) Patent Application Publication
(10) Pub. No.: US 2010/0189386 A1
(43) Pub. Date: Jul. 29, 2010

(54) ANGULAR-CONTACT BALL BEARING IN A TANDEM ARRANGEMENT, AND BEARING ARRANGEMENT HAVING THE ANGULAR-CONTACT BALL BEARING

(75) Inventors: Timur Dizlek, Schweinfurt (DE); Heinz-Dieter Schwerdtfeger, Bad Kohlgrub (DE); Josef Zylla, Schonungen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/670,158

(22) PCT Filed: Jul. 23, 2008
(86) PCT No.: PCT/DE08/01196

§ 371 Date: Feb. 10, 2010

(30) Foreign Application Priority Data
Jul. 25, 2007 (DE) 10 2007 034 813.6

(51) Int. Cl. F16C 19/28

(52) U.S. Cl. 384/512

(57) ABSTRACT

The invention is based on the object of developing an angular-contact ball bearing in a tandem arrangement and a corresponding bearing arrangement. The invention proposes an angular-contact ball bearing (1) having an outer ball row (5), an inner ball row (4) and at least one common bearing race (2) which guides the two ball rows (4, 5), wherein the outer ball row (5) is guided in the angular-contact ball bearing (1) by a two-point bearing arrangement and the inner ball row (4) is guided in the angular-contact ball bearing (1) by a four-point bearing arrangement, and wherein the balls of the outer ball row (5) have a larger diameter than the balls of the inner ball row (4).

### FIELD OF THE INVENTION

The invention relates to an angular-contact ball bearing having an outer ball row and an inner ball row and at least one common bearing race, which guides the two ball rows, the outer ball row being guided in the angular-contact ball bearing by a two-point bearing and the inner ball row by a four-point bearing.

Such angular-contact ball bearings or bearing arrangements are generally used to guide a wheel or the like tightly in an axial direction relative to a surrounding construction, the axial load in a main load direction being absorbed and/or transmitted by both ball rows and the axial load in the opposite direction, that is to say in a secondary load direction, being transmitted or absorbed solely by one ball row. For this purpose, the axial load in the main load direction is transmitted and/or absorbed by the two-point bearing and the four-point bearing, and the axial load in the secondary load direction is transmitted and/or absorbed solely by the four-point bearing.

Another common alternative for the absorption of such axial loads is the use of a bearing arrangement comprising a four-point roller bearing and a separate external radial roller bearing. In this bearing arrangement the radial loads in the main load direction are absorbed by the external radial roller bearing and the four-point roller bearing. In the secondary load direction, on the other hand, the load is absorbed solely by the four-point bearing.

It is furthermore common practice to use bearing arrangements comprising a pair of angular-contact ball bearings in an X-arrangement or an O-arrangement and a cylindrical roller bearing. The radial loads are in this case dissipated by the cylindrical roller bearing and the axial loads by two angular-contact ball bearings placed in an X-arrangement or an O-arrangement.

DE 198 39 481 A1 discloses a transfer case for a motor vehicle having two unilaterally loadable two-row tandem angular-contact ball bearings, separated at distance from one another, for supporting a bevel gear pinion shaft, the tandem angular-contact ball bearings being placed in an O-arrangement relative to one another. In this bearing arrangement the axial load in the one load direction is absorbed by the one tandem angular-contact ball bearing and in the opposite direction by the other angular-contact ball bearing.

An INA product catalog discloses a two-row angular-contact ball bearing in a tandem arrangement, which probably forms the closest prior art. In the TDR series, the two-row angular-contact ball bearing has a common outer race and an inner race divided in an axial direction, an outer ball row being guided by a two-point bearing and an inner ball row by a four-point bearing, so that the two-row angular-contact ball bearing is axially loadable in both directions.

The object of the invention is to develop an angular-contact ball bearing in a tandem arrangement or an equivalent bearing arrangement.

This object is achieved by an angular-contact ball bearing having the features of claim 1 and a bearing arrangement having the features of claim 9. Preferred or advantageous embodiments of the invention are set forth in the dependent claims, in the following description and/or in the drawings attached.

The angular-contact ball bearing according to the invention has an outer ball row and an inner ball row, which are each of annular and/or circular design and which, in axial projection and/or in an axially extending direction, are arranged offset in relation to one another and particularly in radial top view are arranged without any overlap. The two ball rows are, in particular, positioned without contact to one another and/or coaxially with one another. The outside diameter of the outer ball row is greater in the radial extent than the outside diameter of the inner ball row. This arrangement preferably corresponds to a tandem arrangement.

The angular-contact ball bearing has at least one common bearing race, which guides the two ball rows, the common bearing race being of one-piece, axially undivided and/or integral design. The bearing race therefore has one raceway for each ball row, on which the balls of the ball rows can run or roll.

The outer ball row is guided in the angular-contact ball bearing via a two-point bearing, preferably in such a way that only a single axis of compression is formed for the individual balls of the outer ball row. In particular, the outer ball row with the two-point bearing is loadable only in an axial main load direction, which is oriented parallel to the bearing axis.

The inner ball row on the other hand is supported in the angular-contact ball bearing via a four-point bearing, so that two axes of compression oriented in an O-arrangement are formed for the individual balls of the inner ball row. In particular, the inner ball row with the four-point bearing is loadable both in the main load direction and in a secondary load direction, which is likewise oriented parallel to the bearing axis, but points in the opposite direction to the main load direction. The axes of compression of the inner ball row are preferably oriented symmetrically to a radial plane, which is arranged perpendicularly to the bearing axis and leads through the centers of the balls of the inner ball row. It is furthermore preferable that the axes of compression of the inner and outer ball rows running in the same direction be arranged parallel.

According to the invention, the balls of the outer ball row have a larger ball diameter than the balls of the inner ball row.

One aspect of the invention is based on the finding that in the angular-contact ball bearing according to the closest prior art for example, the ball diameters are usually selected so that the axial load acting in the main load direction is similarly distributed to the inner ball row and the outer ball row. For this purpose, the balls of the inner ball row are designed larger than the ball diameter of the outer ball row. By contrast, the invention proposes selecting the ratio between the diameters of the balls of the two ball rows so that a greater proportion of the axial load in the main load direction occurs via the outer ball row and a smaller proportion is absorbed via the inner ball row both in the main load direction and in the secondary load direction. With this development according to the invention it is possible to merely employ a compact angular-contact ball bearing of small axial dimensions, for example in applications which in operation have a directed axial force and which have to absorb an axial back thrust outweighing the axial operating pressure only under special operating conditions, for example occasionally, particularly when running a unit up and down. There is, in particular, no need to use a full, expensive axial back thrust bearing. The invention therefore makes it possible to absorb back thrusts, which occur in smaller magnitude, particularly in the case of shafts to be guided tightly and precisely in an axial direction, in a cost-effective bearing subject to little friction and noise.

In a preferred embodiment, the outer ball row has a larger pitch circle and pitch diameter than the inner ball row. This embodiment again emphasizes the inventive idea that the outer ball row should absorb a greater proportion of the axial loads and pressures occurring in the main load direction.

In a preferred design embodiment, the common bearing race is embodied as an outer race, the outer race having two raceways arranged coaxially with respect to one another for the inner ball row and the outer ball row.

For radially inner support of the ball rows, the angular-contact ball bearing preferably has an inner race arrangement, which comprises an inner race and a retaining ring. The inner race arrangement thereby takes the form of an inner race divided in an axial direction, which facilitates assembly of the angular-contact ball bearing. In the fitted state the inner race and the retaining ring are preferably firmly braced relative to one another in an axial direction, so that the angular-contact ball bearing is also applicable as a fixed bearing. The axial play between the retaining ring and the inner race is designed to be small, for example less than 50 μm, preferably less than 30 μm and in particular less than 10 μm.

In dividing the inner race arrangement into the two inner race parts, the inner race preferably has one raceway for the outer ball row and one raceway for the inner ball row and/or the retaining ring has a raceway for the inner ball row.

The raceways of the inner race arrangement are preferably oriented so that the two raceways of the inner race are oriented in the same direction as one another, so that the axes of compression in each case run parallel to one another and so that the raceway of the retaining ring is oriented in the opposite direction thereto. In particular, in the assembled state one of the two raceways of the inner race and the raceway of the retaining ring form an inner groove. The bearing race in the form of an outer race represents an outer groove for the inner ball row, so that the four-point bearing for the balls of the inner ball row is afforded by the inner groove and the outer groove.

In preferred embodiments of the invention, one of the following materials is chosen as race material for the bearing race and/or the inner race arrangement: 100Cr6 (1.3505), 100CrMn6 (1.3520), 100CrMnSi6-4 (1.3520A), C56E2 (1.1219L, 1.1219M), particularly using top-quality material. The surfaces are optionally wear-protected, for example by carbon-nitrided surfaces, in particular with a penetration depth of approximately 0.1 mm, which are preferably used in the case of fully hardening roller bearing steels (hardened martensitically, for example 100Cr6 or 100CrMn6). The surface roughness of the raceways is preferably Ra<0.1 μm.

The angular-contact ball bearing optionally has a cage for one ball row or for each ball row, the cage preferably being embodied as a plastic cage, in particular one composed of a glass-fiber reinforced plastic, polyamide PA66 or as an injection molded or milled cage of Peak or PPS plastic.

In a preferred development of the invention the angular-contact ball bearing has one or more lubricant feed channels, the outlet opening(s) of which is/are arranged in an axial direction between the two ball rows. The lubricant feed channel(s) is/are preferably oriented radially so that this/these extend(s) radially from the bearing axis. The inlet opening(s) is/are preferably arranged in a circumferential lubricant groove, which runs radially around the outer race of the angular-contact ball bearing. The lubricant feed channel(s) is/are preferably designed so that lubricant greases and/or lubricant oils can be used.

A further subject of the invention relates to a bearing arrangement for supporting a wheel, a rotor or a screw, particularly in a screw compressor, the arrangement according to the invention comprising an angular-contact ball bearing according to one of the preceding claims or as has just been described. The bearing arrangement according to the invention affords an accurate guide between the supported component and a housing or a machine unit in which this component is to be tightly guided in an axial direction. The compressive force which usually occurs in the operation of the machine unit is absorbed via the two ball rows of different ball diameters and preferably different pitch circles. The small back thrusts which occur comparatively rarely, however, are on the other hand absorbed by way of the four-point bearing, preferably via the retaining ring of the inner race arrangement. Particular advantages accrue from the invention in that the bearing arrangement with the angular-contact ball bearing is easier to manufacture than the majority of known solutions, since there are no additional fitting procedures or production operations.

In a preferred development of the bearing arrangement this comprises at least a second angular-contact ball bearing arrangement, in particular in a tandem arrangement, the axes of compression of the angular-contact ball bearing arrangement being oriented in the same direction as the axes of compression of the two-point bearing of the outer ball row. The axes of compression of the second angular-contact ball bearing arrangement are preferably oriented parallel to the axes of compression of the two-point bearing.

Further features, advantages and effects of the invention are set forth in the following description of preferred exemplary embodiments and the attached figures of the invention, in which:

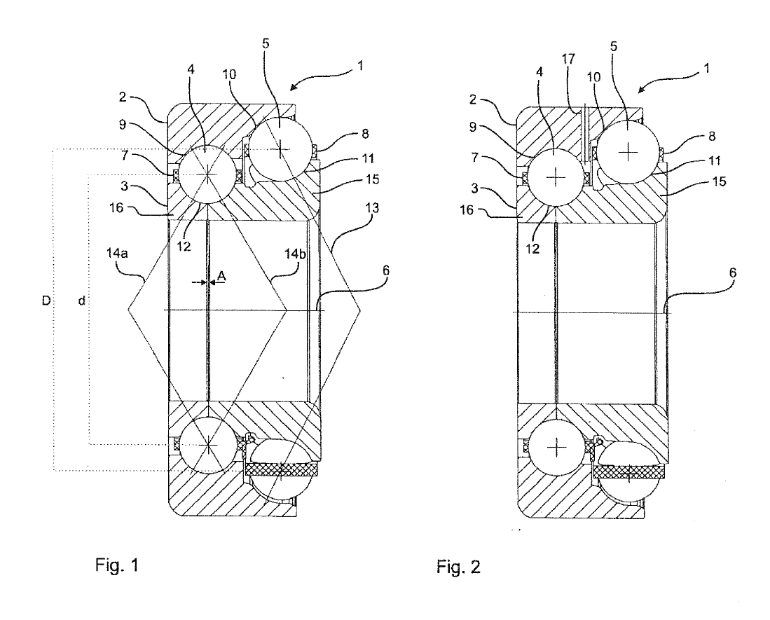

FIG. 1 shows a schematic longitudinal section through an angular-contact ball bearing as a first exemplary embodiment of the invention;

FIG. 2 shows a similar representation of a modified embodiment of the angular-contact ball bearing in FIG. 1 as a second exemplary embodiment of the invention; and

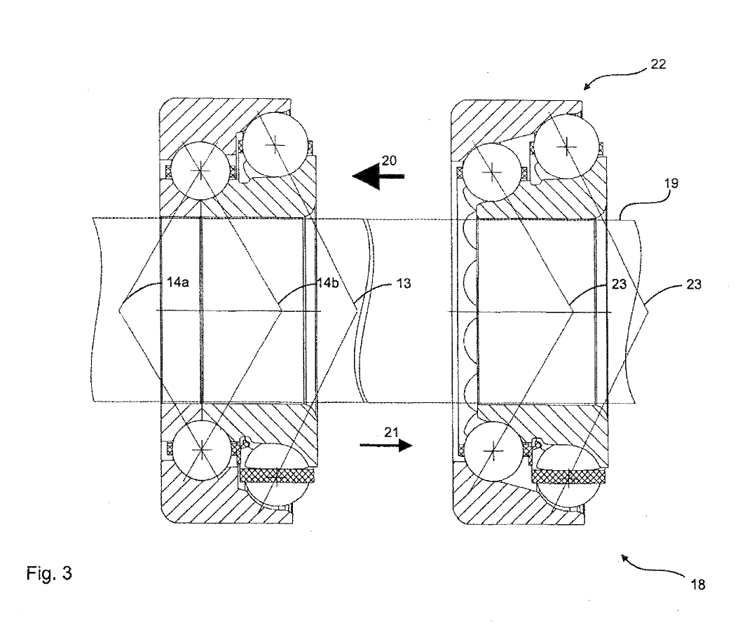

FIG. 3 shows a schematic longitudinal section through a bearing arrangement for supporting a shaft with the angular-contact ball bearing according to FIG. 1.

In the figures corresponding or identical parts are in each case provided with the same reference numerals.

FIG. 1 shows a schematic longitudinal section through an angular-contact ball bearing 1. The angular-contact ball bearing 1 comprises a one-piece outer race 2 and an inner race arrangement 3, between which an inner ball row 4 and an outer ball row 5 run or roll. The two ball rows 4, 5 are oriented in a ring shape, which is arranged coaxially with respect to a bearing axis 6, and are guided in cages 7 and 8 respectively. The selected pitch diameter d of the inner ball row 4 is smaller than the pitch diameter D of the outer ball row. The difference between the pitch diameters is in the order of approximately half the diameter of the balls of the inner ball row 4. In addition, the diameter of the balls of the outer ball row 5 is larger than the diameter of the balls of the inner ball row 4. The ratio between the diameters of the balls of the outer ball row 5 and the balls of the inner ball row 4 is in the order of or equal to the ratio between the pitch diameter D and the pitch diameter d.

The inner ball row 4 and the outer ball row 5 are therefore positioned in a tandem arrangement, so in the longitudinal section shown, these rows are arranged in a stepped manner offset in relation to one another.

The outer race 2 is of one-piece or integral design and has an outer groove 9 for guiding the balls of the inner ball row 4 and an outer raceway shoulder 10 for guiding the outer ball row 5.

The inner race arrangement 3 has an inner raceway shoulder 11 as opposing raceway to the outer raceway shoulder 10 and an inner groove 12 as opposing raceway to the outer groove 9.

The raceway shoulders 10, 11 and the grooves 9, 12 are designed so as to produce a two-point bearing for the balls of the outer ball row 5, the corresponding two-point axis of compression 13 in FIG. 1 being inclined to the right in the area of the bearing axis 6. The outer groove 9 and the inner groove 12 provide a four-point bearing for the balls of the inner ball row 4, so that the four-point axes of compression 14a and 14b are set in an O-arrangement relative to one another.

Not least for assembly reasons, the inner race arrangement 3 is of divided construction in an axial direction and comprises an inner race 15 and a retaining ring 16, which are braced relative to one another in an axial direction with an axial play A, for example of <10 μm. The inner race 15 carries the inner raceway shoulder 11 and a first axial part section of the inner groove 12. The retaining ring 3 on the other hand carries the second part section of the inner groove 12. As can be seen from FIG. 1, the inner groove 12 is centrally divided through the sectional plane between the retaining ring 16 and the inner race 15.

FIG. 2 shows a modified embodiment of the angular-contact ball bearing 1 in FIG. 1, in which, in contrast to the embodiment in FIG. 1, a lubricant feed channel 17 is provided, which for feeding lubricant grease or lubricant oil in the outer race 2 extends in a radial direction from the outside of the outer race 2 into the rolling element space between the ball rows 4, 5. A lubricant groove may optionally be introduced into the outer race on the inlet side of the lubricant feed channel 17.

FIG. 3—likewise in a schematic longitudinal section—shows a bearing arrangement 18 for supporting a shaft 19 or in alternative embodiments a wheel, rotor, rotor shaft, transmission shaft or the like, which is guided in relation to a machine unit, housing or support (not shown). One possible example of use is in a screw compressor. The shaft 19 is shown interrupted in the middle in order to indicate graphically that, among other things, further components may be located in the interrupted area. In operation the shaft 19 transmits compressive forces in an axial main load direction according to the arrow 20 and secondary load forces in the opposite direction according to the arrow 21. This load distribution may occur, for example, in applications which in operation have a directed axial force and in which an axial back thrust outweighing the axial operating pressure is formed only occasionally under special operating conditions, for example when running a unit up and down. In order to absorb the axial compressive forces, the bearing arrangement 18 has a tandem bearing 22 absorbing the operating pressures in the main load direction 20, and the angular-contact ball bearing 1 according to FIG. 1 or FIG. 2 provided with a four-point bearing for absorbing the back thrusts occurring. As is apparent from the distribution of the axes of compression 13, 23, 14a,b in FIG. 3, the bearing arrangement 18 can be loaded asymmetrically, the bearing arrangement 18 being capable of absorbing a higher axial load or pressures in the main load direction 20 than in the opposite direction according to the arrow 21.

In alternative embodiments, the tandem bearing 22 and the angular-contact ball bearing 1 are arranged differently so that, for design reasons, for example, the angular-contact ball bearing 1 and the tandem bearing 22 can be laterally inverted in relation to one another.

To sum up, the bearing arrangement 18 makes it possible to absorb comparatively small back thrusts in operation by means of a cost-effective bearing subject to little friction and noise.

### LIST OF REFERENCE NUMERALS

1 Angular-contact ball bearing

2 Outer race

3 Inner race arrangement

4 Inner ball row

5 Outer ball row

6 Bearing axis

7 Cage of the inner ball row

8 Cage of the outer ball row

9 Outer groove

10 Outer raceway shoulder

11 Inner raceway shoulder

12 Inner groove

13 Axis of compression of the two-point bearing

14a,b Axes of compression of the four-point bearing

15 Inner race

16 Retaining ring

17 Lubricant channel

18 Bearing arrangement

19 Shaft

20 Arrow in main load or main pressure direction

21 Arrow in secondary load or counter-pressure direction

22 Angular-contact ball bearing in tandem arrangement

23 Axes of compression of the angular-contact ball bearing 22

1. An angular-contact ball bearing, comprising:
an outer ball row;
an inner ball row; and
at least one common bearing race, which guides the outer ball row and the inner ball row, the outer ball row being guided in the angular-contact ball bearing by a two-point bearing and the inner ball row by a four-point bearing,
wherein balls of the outer ball row have a larger diameter than the balls of the inner ball row.

2. The angular-contact ball bearing of claim 1, wherein the outer ball row has a larger pitch circle than the inner ball row.

3. The angular-contact ball bearing of claim 1, wherein the bearing race is a one-piece outer race.

4. The angular-contact ball bearing claim 1, further comprising an inner race arrangement, which comprises an inner race and a retaining ring.

5. The angular-contact ball bearing of claim 4, wherein the inner race has one raceway each for the outer ball row and the inner ball row.

6. The angular-contact ball bearing of claim 4, wherein the retaining ring has a raceway for the inner ball row.

7. The angular-contact ball bearing of claim 6, wherein in a longitudinal section, parallel or coplanar with a bearing axis, the two raceways of the inner race are oriented in a same direction as one another and in that the raceway of the retaining ring is oriented in an opposite direction thereto.

8. The angular-contact ball bearing of claim 1, further comprising a lubricant feed channel, an outlet opening of which is arranged axially between the outer ball row and the inner ball row.

9. A bearing arrangement for supporting a wheel, a rotor or a screw in a screw compressor, comprising the angular-contact ball bearing as claimed in claim 1.

10. The bearing arrangement of claim 9, further comprising a second angular-contact ball bearing arrangement, an axis of compression of the second angular-contact ball bearing arrangement being oriented in a same direction as an axis of compression of the two-point bearing of the outer ball row.
